(19) United States
(12) Patent Application Publication
(10) Pub. No.: US 2021/0311602 A1
(43) Pub. Date: Oct. 7, 2021

(54) DETECTION DEVICE

(71) Applicant: Japan Display Inc., Tokyo (JP)

(72) Inventors: Yoshikazu HASHIBA, Tokyo (JP); Satoshi ISHIDA, Tokyo (JP)

(21) Appl. No.: 17/220,132

(22) Filed: Apr. 1, 2021

(30) Foreign Application Priority Data
Apr. 1, 2020 (JP) 2020-065758

(51) Int. Cl. G06F 3/041; G06F 3/044; G06F 3/047

(52) U.S. Cl. CPC G06F 3/04164; G06F 3/0445; G06F 3/0446; G06F 2203/04111; G06F 3/047; G06F 2203/04103; G06F 3/0448

(57) ABSTRACT

A detection device includes at least one first electrode disposed in a detection part, a second electrode disposed outside the detection part and surrounding the detection part, a third electrode overlapped with the detection part, a first insulating layer between the at least one first electrode and the third electrode, and a second insulating layer covering the third electrode.

### CROSS-REFERENCE TO RELATED APPLICATIONS

This application is based upon and claims the benefit of priority from the prior Japanese Patent Application No. 2020-065758, filed on Apr. 1, 2020, the entire contents of which are incorporated herein by reference.

### FIELD

An embodiment of the present invention relates to a detection device. An embodiment of the invention disclosed in this specification relates to a detection device for detecting minute irregularities on a surface of an object to be detected.

### BACKGROUND

Contact type detection device for recognizing a fine surface shape such as a fingerprint is known. For example, there is disclosed a detection device having a plurality of sensor electrodes arranged in a matrix, a passivation film covering the sensor electrodes, a capacitance detection circuit for detecting the capacitance generated between the sensor electrodes and the surface of the detection object when the detection object contacts the surface of the passivation film, and a ground electrode for eliminating static electricity on the surface of the passivation film (for example, Japanese Patent Application Laid-Open No. 2001-324303).

### SUMMARY

A detection device in an embodiment according to the present invention includes at least one first electrode disposed in a detection part, a second electrode disposed outside the detection part and surrounding the detection part, a third electrode overlapped with the detection part, a first insulating layer between the at least one first electrode and the third electrode, and a second insulating layer covering the third electrode.

### BRIEF DESCRIPTION OF DRAWINGS

FIG. 1 is a block diagram showing a detection device according to an embodiment of the present invention;

FIG. 2 shows an example of a circuit configuration of a detection part of a detection device according to an embodiment of the present invention;

FIG. 3 schematically shows a mode in which a detection signal is transmitted from a transmission electrode of a detection device according to an embodiment of the present invention to a first electrode via a detection object;

FIG. 4 is a plan view showing a configuration of a detection device according to an embodiment of the present invention, and schematically shows a substrate on which a detection part is disposed, and transmission electrodes disposed outside the substrate;

FIG. 5 is a plan view showing a detection part of a detection device according to an embodiment of the present invention, and is an enlarged view showing a structure of an area D surrounded by a dotted line shown in FIG. 4;

FIG. 6 is a cross-sectional view showing a detection part and a peripheral region of a detection device according to an embodiment of the present invention, and shows a structure corresponding to lines A1-B1 and a structure of a guard ring shown in FIG. 5;

FIGS. 7A and 7B are plan views showing a configuration of a terminal part of a detection device according to an embodiment of the present invention;

FIG. 8 is a cross-sectional view showing a structure of a terminal part of a detection device according to an embodiment of the present invention;

FIGS. 9A and 9B are plan views showing a pattern of a third electrode of a detection device according to an embodiment of the present invention; and

FIGS. 10A and 10B are plan views showing a pattern of a third electrode of a detection device according to an embodiment of the present invention.

### DESCRIPTION OF EMBODIMENTS

Hereinafter, embodiments of the present invention will be described with reference to the drawings and the like. The present invention may be carried out in various embodiments, and should not be construed as being limited to any of the following embodiments. In the drawings, components may be shown schematically regarding the width, thickness, shape and the like, instead of being shown in accordance with the actual sizes, for the sake of clear illustration. The drawings are merely examples and do not limit the present invention in any way. In the specification and the drawings, components that are substantially the same as those described or shown previously bear the identical reference signs thereto (or the identical reference signs followed by letters “a”, “b” or the like), and detailed descriptions thereof may be omitted. The terms “first”, “second” and the like used for elements are merely provided for distinguishing the elements and do not have any other significance unless otherwise specified.

In this specification, when certain components or region is considered to be “above (or below)” of another component or region, this includes, without particular limitation, not only when it is directly above (or directly below) another component or region, but also when it is above (or below) another component or region. That is, it includes the case where another component is included in between above (or downward) the other component or region.

A detection device according to an embodiment of the present invention is configured to detect a change in capacitance when an object to be detected contacts or approaches a detection surface. For example, the detection device can be configured as a biometric sensor by utilizing this function. Specifically, the detection device can be used as a biometric authentication sensor for detecting features of the human body such as fingerprints and palm prints. Hereinafter, the detection device according to the present embodiment will be described in detail.

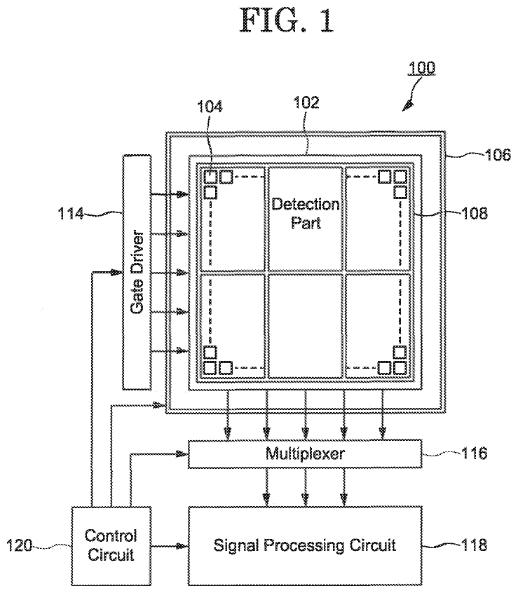

FIG. 1 is a block diagram of the detection device 100 according to an embodiment of the present invention. The detection device 100 includes a detection part 102 in which a first electrode 104 is disposed, a gate driver 114, a multiplexer 116, a signal processing circuit 118 for processing a signal outputted from the detection part 102, a second electrode 106 for outputting a signal for detection, and a third electrode 108. The second electrode 106 is disposed so as to surround the detection part 102, and the third electrode 108 is disposed at a position overlapping the detection part 102.

The detection device 100 outputs a detection signal between the second electrode 106 and the first electrode 104 and detects the state of the object to be detected. The second electrode 106 transmits a detection signal to the detection part 102, and the first electrode 104 receives the detection signal. The detecting part 102 includes a signal reading circuit formed so as to detect capacitance formed between the first electrode 104 and the second electrode 106. The gate driver 114 outputs a scan signal for selecting the first electrode 104 disposed in the detection part 102. The detection data signal outputted from the detection part 102 is outputted through the multiplexer 116 to the signal processing circuit 118. The control circuit 120 has a function of controlling the operation of the gate driver 114, the multiplexer 116, the second electrode 106, and the signal processing circuit 118.

The detection part 102 of the detection device 100 in this embodiment is disposed on an insulating substrate such as a glass substrate or a resin substrate, or a substrate having an insulating surface (for example, an SOI substrate having an insulating layer formed on the surface of a silicon substrate). The gate driver 114 and the multiplexer 116 disposed in the peripheral region outside the detection part 102 may also be formed on the same substrate.

The second electrode 106 can be called a transmitting electrode because it has a function of transmitting a detection signal. The first electrode 104 can be called a receiving electrode or a detecting electrode because it has a function of receiving a function of receiving a detection signal and outputting a signal to be data (detection data signal). The third electrode 108 can be referred to as a charge eliminating electrode because it has a function of discharging static electricity as described later.

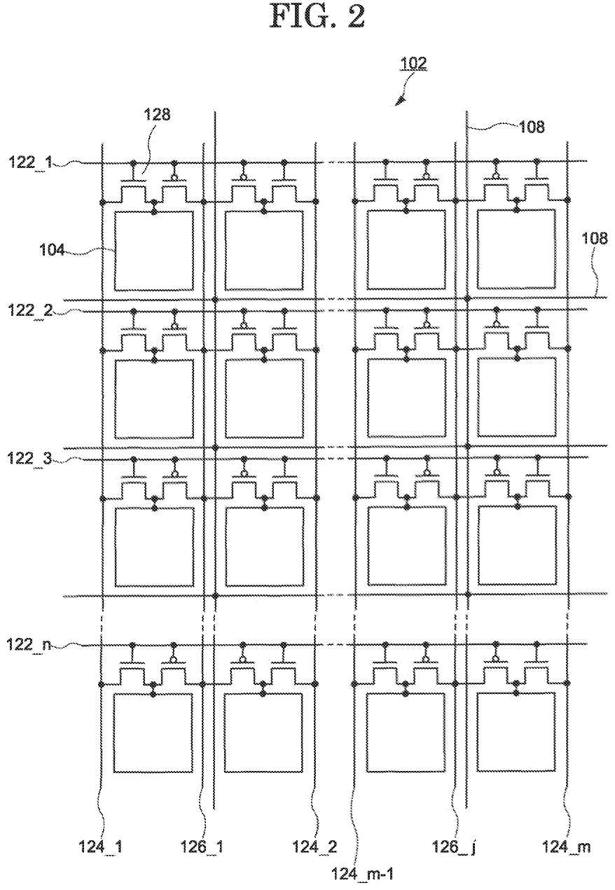

FIG. 2 shows a circuit configuration of the detection part 102. The detection part 102 includes a plurality of first electrodes 104 and is arranged in a matrix. One segment of the detection part 102 is formed by one first electrode 104. A switching element 128 is included in one segment in addition to the first electrode 104. The switching element 128 is connected to a gate signal line 122, and switching operation is performed by a signal from the gate signal line 122.

The switching element 128 is connected to the first electrode 104, a data signal line 124, and a common signal line 126. The switching element 128 forms a complementary switch, and forms one of a state in which the first electrode 104 is connected to the data signal line 124 and a state in which the first electrode 104 is connected to the common signal line 126. A state in which the first electrode 104 of a segment is connected to the data signal line 124 through the switching element 128 is signal reading, and the first electrode 104 of the segment is connected through the switching element 128 to the common signal line 126 in a reset state.

As shown in FIG. 2, the plurality of first electrodes 104 are disposed in a matrix of n rows and m columns. The plurality of gate signal lines 122_1 to 122_n is connected to the gate driver 114 shown in FIG. 1, and the plurality of the data signal lines 124_1 to 124_m is connected to the multiplexer 116 shown in FIG. 1. The plurality of common signal lines 126_1 to 126_j applies signals of a constant voltage (for example, the ground voltage) to the respective first electrodes 104. As shown in FIG. 2, the data signal lines 124_1 to 124_m is disposed for each column, and the common signal lines 126_1 to 126_j may be disposed in every other column so that adjacent columns share each other.

For example, the switching element 128 may be formed of an n-channel transistor and a p-channel transistor, and is formed of a complementary switch by combination of two transistors having different conductivity types. It is possible to control the two states of the first electrode 104 with the binary signals of the H (High) level and the L (Low) level with such a complementary switch. That is, the two states are a state in which the first electrode 104 is connected to the data signal line 124, and a state in which the first electrode 104 is connected to the common signal line 126. Note that the switching element 128 is not limited to the one shown in FIG. 2, and may be replaced with another configuration as long as it has the same function.

As shown in FIG. 2, for example, with respect to the plurality of first electrodes 104 arranged in a matrix in n rows and m columns, the plurality of gate signal lines 122_1 to 122_n is arranged for each row, and the plurality of data signal lines 124_1 to 124_m is arranged for each column. The gate driver 114 sequentially outputs selection signals to a plurality of gate signal lines 122_1 to 122_n, and data signals of the selected row are inputted to the multiplexer 116 through data signal lines 124_1 to 124_m of each column.

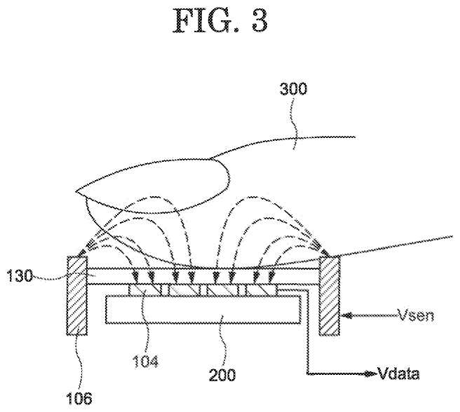

FIG. 3 schematically shows an aspect in which a detection signal is transmitted from the second electrode 106 to the first electrode 104 through the detection object 300. The first electrode 104 is disposed on a substrate 200, and the second electrode 106 is disposed surrounding the substrate 200. The second electrode 106 and the first electrode 104 are separated at a predetermined interval, and the detection signal Vsen is transmitted from the second electrode 106 toward the first electrode 104. Dielectric material such as air and a cover glass 130 is interposed between the second electrode 106 and the first electrode 104. The second electrode 106 and the first electrode 104 are considered to form one capacitor, and a certain capacitance is formed by the detection signal Vsen. On the other hand, when the detection object 300 (for example, a finger of a human body) having conductivity comes into contact with or approaches the first electrode 104, the state of the electric field changes. That is, when the detection object 300 acts as an electrode, the distance between the second electrode 106 and the first electrode 104 becomes substantially shorter and the capacitance increases. At least one detection data signal Vdata is output from the first electrode 104.

Although FIG. 3 shows only a schematic structure, the resolution of the detection device 100 can be increased by miniaturizing the first electrode 104. For example, the unevenness of the fingertips of the human body due to fingerprints can be read as a change in capacitance. That is, the detection device 100 can function as a fingerprint detection device. If the size of the detection part 102 is such that the palm can be touched, the detection device 100 can function as a palmprint detection device.

If the substrate 200 is a glass substrate or a resin substrate, discharge current flows into the circuit provided in the detection part 102 when electrostatic discharge (ESD) occurs in the detection part 102. That is, since the detection part 102 is not provided with a path for eliminating the electrostatic discharge, the detection circuit provided in the detection part 102 as shown in FIG. 2 is electrostatically destroyed.

The detection device 100 according to the present embodiment is provided with the third electrode 108 to solve such a problem. The third electrode 108 is disposed in a region overlapping the detection part 102 as shown in FIG. 1. The third electrode 108 is arranged so as to overlap a matrix in which a plurality of first electrodes 104 are arranged in a circuit diagram, as shown in FIG. 2. The third electrode 108 can be disposed appropriately in one or both directions of the row direction and the column direction of the detection circuit. The third electrode 108 is insulated from the gate signal line 122, the data signal line 124, the common signal line 126, the switching element 128, and the first electrode 104. That is, the gate signal line 122, the data signal line 124, the common signal line 126, the switching element 128, and the first electrode 104 form the detection circuit, and the third electrode 108 forms the charge elimination circuit independent of the detection circuit. The third electrode 108 is arranged in such a manner that the detection circuit and the charge elimination circuit are overlapped, but electrically separated from each other. The third electrode 108 is preferably made low in resistance in order to eliminate electrostatic discharge. The third electrode 108 is preferably formed of a metallic material such as aluminum (Al), copper (Cu), or silver (Ag).

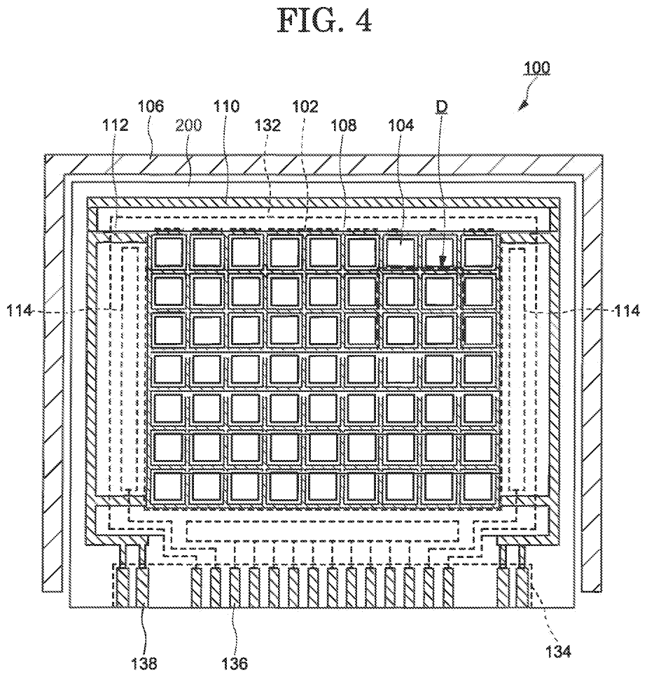

FIG. 4 is a plan view schematically showing the configuration of the substrate 200 provided with the detection part 102 and the arrangement of the second electrode 106 provided outside the substrate 200. The substrate 200 is an insulating substrate such as a glass substrate or the like, or a substrate having an insulating surface on which an insulating film is formed (for example, an SOI substrate). The detection part 102, the third electrode 108, first wiring 110, second wiring 112, and the terminal part 134 are provided on the substrate 200. The circuit such as the gate driver 114 and the multiplexer 116 may be provided on the substrate 200. The second electrode 106 is formed of a conductive member separately from the substrate 200 and is provided so as to surround the substrate 200.

The detection part 102 includes the plurality of first electrodes 104 and the third electrode 108. The plurality of first electrodes 104 are arranged in a matrix form, for example, in two directions crossing the first direction and the first direction. The detection part 102 has a rectangular region formed by the arrangement of the plurality of first electrodes 104. The plurality of first electrodes 104 are spaced apart from each other in the detection part 102. The third electrode 108 does not overlap the plurality of first electrodes 104, and is disposed in a region where the plurality of first electrodes 104 are separated from each other. The third electrode 108 is disposed over the entire surface of the detection part 102 so as to form a static elimination path for electrostatic discharge. For example, the third electrode 108 is formed in a stripe-like (linear) or grid-like pattern at the detection part 102.

The gate driver 114 and the multiplexer 116 may be disposed on the substrate 200 in a region outside of the detection part 102 (outside of the third electrode 108). The terminal part 134 is disposed on substrate 200. The plurality of first terminals 136 are disposed in the terminal portion 134. The plurality of first terminals 136 include an input terminal to which a signal for driving the gate driver 114 and the multiplexer is inputted, and an output terminal to which an output signal of the multiplexer 116 is outputted.

Guard ring 132 may be disposed on the substrate 200 so as to surround the detection part 102 (and the gate driver 114 and the multiplexer 116). The guard ring 132 can protect the detection part 102 (the gate driver 114 and the multiplexer 116) from external noise. The guard ring 132 can suppress noise radiated from the detection part 102 (the gate driver 114 and the multiplexer 116).

Further, the first wiring 110 is disposed outside (outside the gate driver 114 and the multiplexer 116) the detection part 102 on the substrate 200. The first wiring 110 is disposed around the detection part 102 and reaches the terminal part 134. The first wiring 110 and the third electrode 108 are connected by at least one second wiring 112. At least one second wiring 112 preferably includes a plurality of second wirings 112, and the first wiring 110 and the third electrode 108 are preferably connected to each other at a plurality of positions by the plurality of second wirings 112. For example, it is preferable that the first wiring 110 are connected at four points of the third electrode 108 to the first wiring 110 disposed along the three sides of the detection part 102, as shown in FIG. 4. The plurality of discharge paths for electrostatic discharge can be provided, and the discharge path can be minimized since the first wiring 110 and the third electrode 108 are connected to each other at a plurality of positions.

As shown in FIG. 4, the gate driver 114 is disposed in a region where the third electrode 108 and the first wiring 110 are bridged by the second wiring 112. In other words, the gate driver 114 and the gate signal line 122 extending from the gate driver 114 can be provided so as not to overlap with the first wiring 110 by arranging the third electrode 108 and the first wiring 110 separately and bridging with the second wiring 112. Thus, the formation of a parasitic capacitance between the gate driver 114 and the gate signal line 122, and the first wiring 110 can be prevented, and the lowering of the operation speed and the increase of power consumption can be prevented. The number of the second wiring 112 may be further increased when the gate drivers 114 can be divided and arranged.

The first wiring 110 is connected at the terminal 134 to at least one second terminal 138. The at least one second terminal 138 is connected to an external discharge circuit (grounding wire). The third electrode 108 is connected to the external discharge circuit from through the at least one second wiring 112, the first wiring 110 and the second terminal 138. Thereby, the influence of electrostatic discharge can be effectively removed.

At least one second terminal 138 is disposed apart from the plurality of the first terminals 136. Electrostatic discharge can be prevented from being discharged from the at least one second terminal 138 to the first terminal 136, since the at least one second terminal 138 is spaced apart from the plurality of first terminals 136.

At least one second terminal 138 may include a plurality of second terminals 138, and each of second terminal 138 may be connected to the first wiring 110. Thus, the resistance (contact resistance) at the connection of the first wiring 110 with the external discharge circuit can be reduced, and the electrostatic discharge can be more effectively eliminated. Preferably, at least one second terminal 138 or the plurality of second wirings 112 are disposed on both sides so as to sandwich the plurality of the first terminals 136. Such an arrangement can minimize the discharge path of the electrostatic discharge as described above.

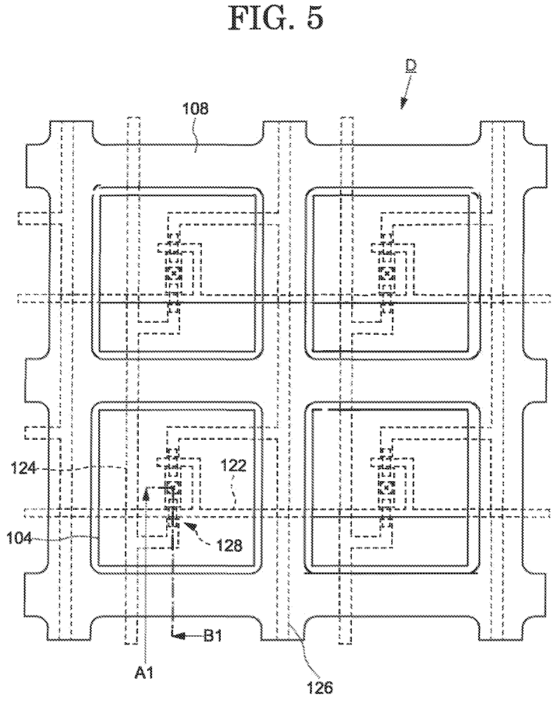

FIG. 5 shows an enlarged view of a region D surrounded by a dotted line shown in FIG. 4. FIG. 5 is a plan view of the detection part 102, and shows four first electrodes 104 and a third electrode 108 disposed so as to surround the four first electrodes 104. Dotted lines in FIG. 5 shows an example of the layout of the gate signal line 122, the data signal line 124, the common signal line 126, and the switching element 128 provided in the detection part 102. However, the form of the detection part 102 is not limited to this layout.

The plurality of first electrodes 104 are disposed separately from each other. The third electrode 108 is disposed so as not to overlap the first electrode 104. In other words, the third electrode 108 is disposed in a region between the plurality of first electrodes 104. The shape of the plurality of first electrodes 104 in plan view is not limited, but may be rectangular or square as shown in FIG. 5, for example. The third electrode 108 are disposed in the row direction and column direction with respect to the arrangement of the first electrodes 104. As shown in FIG. 5, corner edges of the third electrode 108 may be rounded or offset at the intersection (corner of the first electrode 104). In other words, it is preferable that the third electrode 108 is not a pattern having rectangular corners at the intersections where the patterns extending in the row direction and column direction intersect at right angles, but the corners at the intersections are curved at a predetermined radius of curvature and have an arc shape. It is possible to prevent heat generation due to current concentration at the intersections when eliminating electrostatic discharge, since the third electrode 108 has a curved pattern at the intersection.

The switching element 128 is disposed in the detection part 102 corresponding to each of the plurality of first electrodes 104 as shown in FIG. 2. The switching element 128 is connected to the first electrode 104. The detection part 102 also includes the gate signal line 122, the data signal line 124, and the common signal line 126, as shown by dotted line in FIG. 5. The gate signal line 122, the data signal line 124, and the common signal line 126 are disposed on different layers from the first electrode 104. Therefore, part or all of the gate signal line 122, the data signal line 124, and the common signal line 126 may overlap the third electrode 108.

The third electrode 108 and the first electrode 104 are disposed in different layers with the insulating layer interposed therebetween. Therefore, the third electrode 108 may be disposed so as to partially overlap the first electrode 104 (for example, may be disposed so as to overlap the peripheral region of the first electrode 104). In this case, the detection part 102 is improved in resistance to electrostatic discharge, but the detection sensitivity is lowered by electric field shielding. It is preferable that the third electrode 108 is provided so as not to overlap with the first electrode 104 in order not to lower the detection sensitivity of the detection part 102. Further, a gap may be formed between the third electrode 108 and the first electrode 104 in plan view, but when the width of the pattern of the third electrode 108 becomes narrow, resistance to electrostatic discharge is lowered. Therefore, the pattern width of the third electrode 108 is preferably set-in consideration of the tradeoff between the detection sensitivity and the electrostatic resistance.

The switching element 128 is disposed in a region overlapping the first electrode 104. With respect to the gate signal line 122, the data signal line 124 and the common signal line 126 are disposed so as to cross each other. The switching element 128, the gate signal line 122, the data signal line 124, and the common signal line 126 are disposed on the lower layer side than the first electrode 104. As described above, the third electrode 108 and the first electrode 104 are disposed in different layers. In this case, the third electrode 108 is disposed on the upper layer side of the first electrode 104 in order to eliminate electrostatic discharge. Although not shown in FIG. 5, an insulating film is provided as a protective film on the upper surface of the third electrode 108.

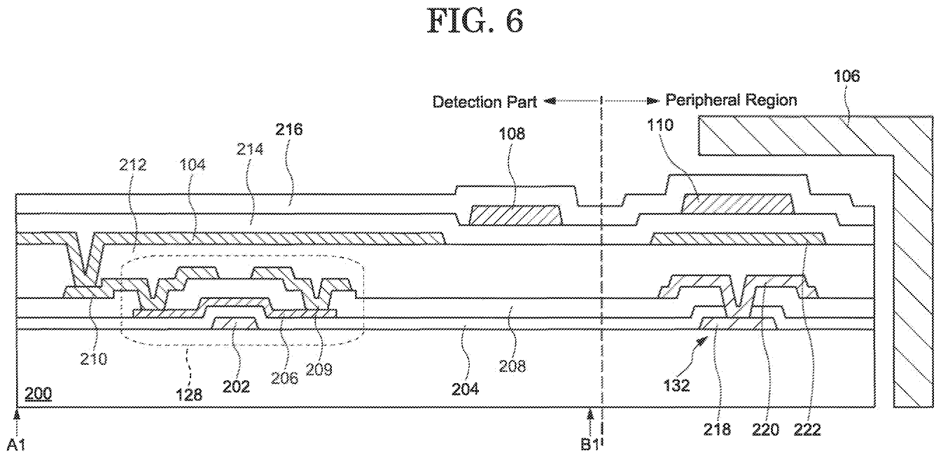

FIG. 6 shows a cross-sectional structure corresponding to the line A1-B1 shown in FIG. 5. FIG. 6 shows a cross-sectional structure of a region around the substrate 200 (area outside the detection part 102) where the guard ring 132 and the first wiring 110 are disposed.

As shown in FIG. 6, a switching element 128 is provided on the substrate 200 in the detection part 102. The switching element 128 is provided by a thin film transistor. The thin film transistor as the switching element 128 has a structure in which a gate electrode 202, a gate insulating layer 204, a semiconductor layer 206, a source electrode 209 and a drain electrode 210 are laminated. The insulating layer has a structure in which the gate insulating layer 204, an interlayer insulating layer 208, a planarization layer 212, a first insulating layer 214, and a second insulating layer 216 are laminated from the side of the substrate 200. The planarization layer 212 is disposed over the entire detection part 102 and the peripheral region. The planarization layer 212 is preferred to embed the switching element 128 to form a flat top surface for the first electrode 104. FIG. 6 shows an example of one thin film transistor as the switching element 128. However, the switching element 128, includes two thin film transistors of different conductivity types, and a complementary switch can be formed, as shown in FIG. 2.

The first electrode 104 is disposed on an upper surface of the planarization layer 212. The first electrode 104 is connected to the switching element 128 via a contact hole formed in the planarization layer 212. The first electrode 104 is formed of a metal film such as aluminum (Al). For example, the first electrode 104 is formed of a structure (Ti/Al/Ti or Mo/Al/Mo) in which titanium (Ti) or molybdenum (Mo) is laminated on the lower layer side and the upper layer side of the aluminum (Al) film. The first electrode 104 may be formed of a conductive oxide such as ITO or IZO, or a metal film such as titanium (Ti) or molybdenum (Mo).

The first insulating layer 214 is disposed on the upper layer side of the first electrode 104. The first insulating layer 214 is disposed over the whole of the detection part 102 and the peripheral region. The first insulating layer 214 is formed of an inorganic insulating material. For example, the first insulating layer 214 is formed of an inorganic insulating film such as a silicon oxide film, a silicon nitride film, or a silicon oxynitride film, or an organic insulating film such as an acrylic film or a siloxane film. The first insulating layer 214 can protect the first electrode 104 and prevent a short circuit with the third electrode 108.

The third electrode 108 is disposed on the upper surface of the first insulating layer 214. The third electrode 108 is formed of the same material and the same structure as the first electrode 104. The third electrode 108 can also be formed of a material such as a metal single layer film, a metal alloy film, a metal laminated film or the like using aluminum (Al), an aluminum-silicon alloy (Al—Si), molybdenum (Mo), titanium (Ti) or the like as a main material. For example, when a metal laminated film is used for the third electrode 108, a structure of Ti/Al/Ti, Mo/Al/Mo or the like in which a layer of titanium (Al) or molybdenum (Mo) is laminated on the lower layer side and the upper layer side of the aluminum (Ti) layer can be adopted. The third electrode 108 is disposed at a position which does not overlap with the first electrode 104.

The second insulating layer 216 is disposed on the upper layer side of the third electrode 108. The second insulating layer 216 is disposed over the entire surface of the detection part 102 and the peripheral region so as to embed the third electrode 108. The second insulating layer 216 is formed from an inorganic insulating material. For example, the second insulating layer 216 is formed of an inorganic insulating film such as a silicon oxide film, a silicon nitride film, or a silicon oxynitride film. The second insulating layer 216 is disposed as a protective film for the third electrode 108. The second insulating layer 216 is preferably thicker than the first insulating layer 214 since it functions as a protective film of the third electrode 108.

The size (dimensions in plan view) of the first electrode 104 is set in consideration of the resolution of the detection part 102. When the area of the detection part 102 is constant, the resolution increases when the first electrode 104 is made small, and the resolution decreases when the first electrode 104 is made large, but the S/N ratio improves. The plurality of first electrodes 104 are arranged at predetermined intervals. The width of the third electrode 108 is equal to or smaller than the interval between the first electrodes.

FIG. 6 also shows the structure of the peripheral region. The guard ring 132 and the first wiring 110 are disposed in the peripheral region. The guard ring 132 is formed by the same conductive layer that forms the detection part 102. For example, the guard ring 132 is formed by one layer or a plurality of layers selected from the first conductive layer 218 forming the gate electrode of the switching element 128, the second conductive layer 220 that is the same as the conductive layer that forms the source electrode 207 and the drain electrode 210, and the third conductive layer 222 that is the same as the conductive layer that forms the first electrode. These conductive layers are provided with insulating layers between the layers, and can be electrically at the same potential by forming contact holes and connecting them to each other, thereby forming a wiring pattern functioning as the guard ring 132.

The first wiring 110 is provided in the same layer as the third electrode 108. The third electrode 108 can be disposed on top of the guard ring 132 by interposing at least the first insulating layer 214. However, the first wiring 110 is disposed in a state insulated from the guard ring 132 so that a current due to electrostatic discharge does not flow into the guard ring 132.

The second electrode 106 is disposed close to the first wiring 110 when the substrate 200 disposed with the detection part 102 is mounted on the detection device 100. If the third electrode 108 is not covered with the insulating layer and is exposed, when an electrostatic discharge occurs in the vicinity of the detection part 102, the electrostatic discharge is induced in the second electrode 106, and the first wiring 110 can be a path for causing the electrostatic discharge to enter the circuit and the element formed on the substrate 200. In order to prevent such an unintended failure, the third electrode 108 is preferably covered with the second insulating layer 216.

As described with reference to FIG. 6, the pattern that forms the detection part 102 and the pattern that eliminates electrostatic discharge can be arranged on different layers, by disposing the first insulating layer 214 on top of the layer that forms the detection part 102, and then placing the third electrode 108 and the first wiring 110 on top of that. In other words, since the third electrode 108 and the first wiring 110 are not connected to each other through the contact hole, the static discharge path of the electrostatic discharge can be arranged independently, and the static discharge path can be prevented from being mixed with the circuit of the detection part 102.

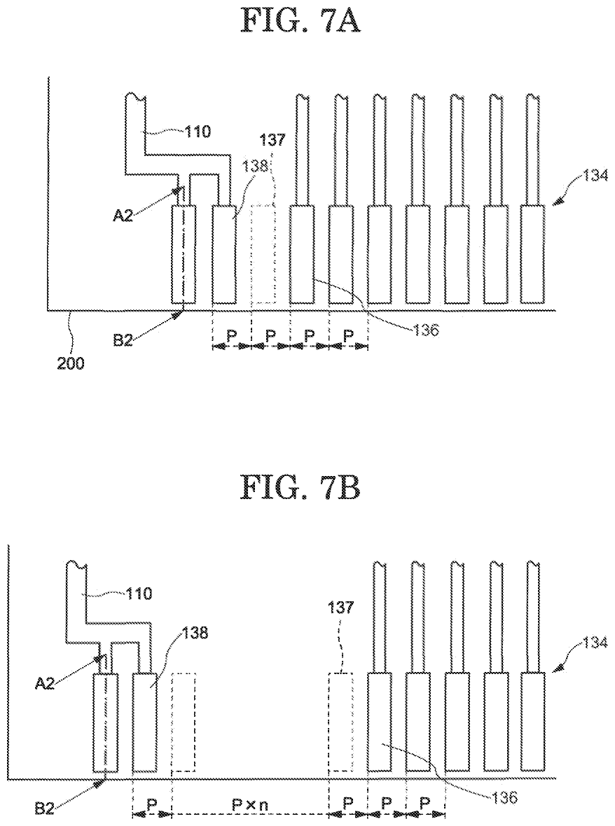

FIG. 7A is a plan view schematically showing the arrangement of the plurality of first terminals 136 and at least one second terminal 138. The plurality of first terminals 136 are arranged along one side of the substrate 200. At least one second terminal 138 is arranged on the same plane as the plurality of first terminals 136. However, when a plurality of first terminals 136 arranged apart from the terminals at the most end of the plurality of first terminals 136 are arranged at a pitch P, at least one second terminal 138 is arranged apart from the terminals at the most end of the plurality of first terminals 136 by 1 pitch. The pitch P of the plurality of first terminals 136 is appropriately set.

The plurality of first terminals 136 are input with a control signal for driving the detection part 102, and output the detection signal of the detection part 102. At least one second terminal 138 is connected to the first wiring 110. The at least one second terminal 138 connects the first wiring 110 to the external discharge circuit. The at least one second terminal 138 may include a plurality of second terminals 138, and the plurality of second terminals 138 may be connected to the third electrode 108. Since the first wiring 110 is connected to the plurality of second terminals 138, redundancy can be enhanced, and a static elimination current can be effectively supplied to an external discharge circuit.

The electrostatic discharge discharged by the third electrode 108 is secondarily discharged from the second terminals 138 to the first terminals 136, when the first terminals 136 and the second terminals 138 are disposed at the same pitch P. The discharge current flows back from the first terminal 136 to the drive circuit, causing damage to the drive circuit, which is a problem, when secondary discharge occurs in such a path.

In order to solve such a problem, it is preferable that the second terminals 138 are arranged at least 1 pitch apart from the terminals at the most end of the plurality of first terminals 136. The second terminal 138 is disposed away from the first terminal 136 to prevent the secondary discharge.

As shown by a dotted line in FIG. 7A, a dummy terminal 137 may be disposed between the first terminal 136 and the second terminal 138. The dummy terminal 137 is a terminal not connected to the detection circuit. A plurality of dummy terminals 137 may be arranged. The secondary discharge can also be prevented by arranging the dummy terminals 137.

FIG. 7B shows an example in which the second terminal 138 is disposed further away from the first terminal. The at least one second terminal 138 may be arranged at a distance of several pitches or more from the electrode at the most end of the plurality of first terminals 136. For example, at least one second terminal 138 may be disposed at a distance from the first terminal 136 by 5 pitches or more, or further by 10 pitches or more. Resistance to electrostatic discharge can be enhanced since the second terminal 138 for charge elimination is disposed away from the first terminal 136 for signal input/output.

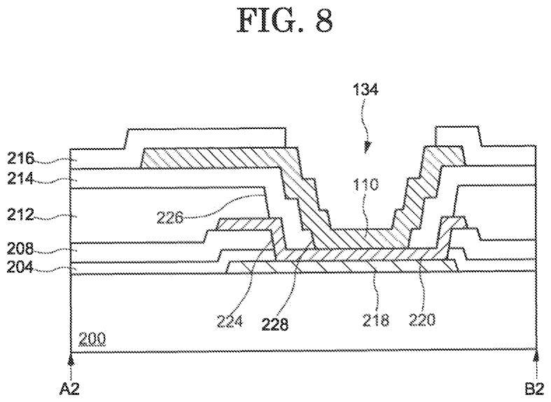

FIG. 8 shows an example of the cross-sectional structure of the second terminal 138 shown in FIG. 7A and FIG. 7B along line A2-B2. The second terminal 138 has a structure in which the first conductive layer 218 formed on the substrate 200 and the second conductive layer 220 are laminated. The first conductive layer 218 is formed of the same conductive layer as the conductive layer forming the gate electrode of the switching element 128. The second conductive layer 220 is formed of the same conductive layer as the conductive layer forming the source electrode and the drain electrode. The second terminal 138 includes the first conductive layer 218 and the second conductive layer 220, and the first conductive layer 218 and the second conductive layer 220 have a rectangular shape in plan view as shown in FIG. 7A and FIG. 7B.

The gate insulating layer 204, the interlayer insulating layer 208, the planarization layer 212, the first insulating layer 214, and the second insulating layer 216 formed in the detection part 102 extend to the region of the second terminal 138. The gate insulating layer 204 and the interlayer insulating layer 208 have a first openings 224 that expose the top surface of the first conductive layer 218. The second conductive layer 220 includes a region overlapping the first opening 224 and is disposed in contact with the first conductive layer 218. The planarization layer 212 has a second opening 226 for exposing the upper surface of the second conductive layer 220. The second insulating layer 216 has a third opening 226 overlapping the second opening 228. The upper surface of the second conductive layer 220 is exposed by the second opening 226 and the third opening 228. The first wiring 110 disposed on the first insulating layer 214 extends to a region on the upper surface of the second conductive layer 220, and is disposed in contact with the second conductive layer 220 at the third opening 228. With this structure, the second terminal 138 is electrically connected to the first wiring 110. Although not shown, the first terminal 136 has the same structure as the second terminal 138 in which the first conductive layer 218 and the second conductive layer 220 are laminated.

FIG. 4 shows a configuration in which the third electrode 108 surrounds each of the first electrodes 104. As shown in FIG. 4, the lattice pattern of the third electrode 108 has the highest density and exhibits high immunity to electrostatic discharge. On the other hand, since the third electrode 108 can be regarded as a shield electrode for shielding the electric field, it has a characteristic that the detection sensitivity of the detection part 102 is lowered. The density of the third electrode 108 has a contradictory relationship with respect to resistance to electrostatic discharge and detection sensitivity. The detection device 100 according to the present embodiment can appropriately adjust the density of the third electrode 108 according to a required characteristic.

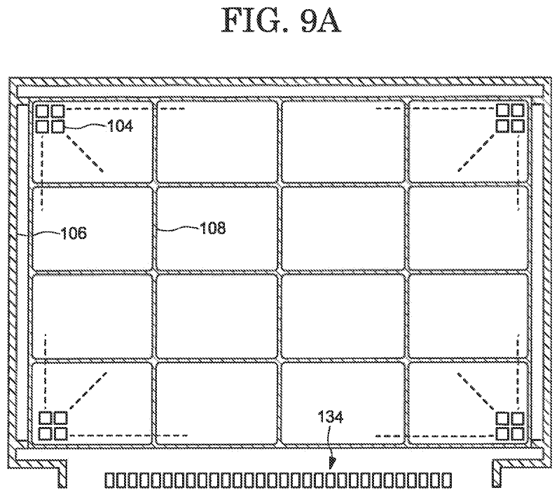

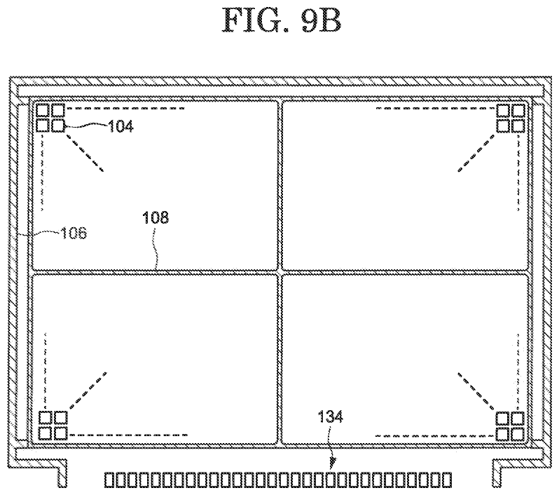

For example, FIG. 9A shows an example in which the third electrode 108 is disposed at a medium density. The third electrode 108 shown in FIG. 9A has a grid pattern, but unlike the pattern of the third electrode 108 shown in FIG. 4, the plurality of first electrodes 104 are arranged in one grid. FIG. 9B shows an example in which the third electrode 108 has a lattice pattern of a lower density. The third electrode 108 shown in FIG. 9B is provided with only a rectangular pattern surrounding the outer contour of the detection part 102, and a linear pattern extending in the vertical direction and the lateral direction so as to intersect at a substantially central portion.

When the charge elimination performance of the third electrode 108 is compared, the neutralization performance of the closest grid pattern shown in FIG. 4 is relatively high, and the neutralization performance of the lowest dense grid pattern shown in FIG. 9B is relatively low. On the other hand, in the viewpoint of the detection sensitivity, the lattice pattern of the third electrode 108 shown in FIG. 9B has the highest detection sensitivity, and the closest lattice pattern shown in FIG. 4 has low detection sensitivity. In any case, when the detection sensitivity of the detection device 100 is emphasized, the pattern of the third electrode 108 may be arranged at a low density, and when the immunity to electrostatic discharge is emphasized, the pattern of the third electrode 108 may be arranged at a high density.

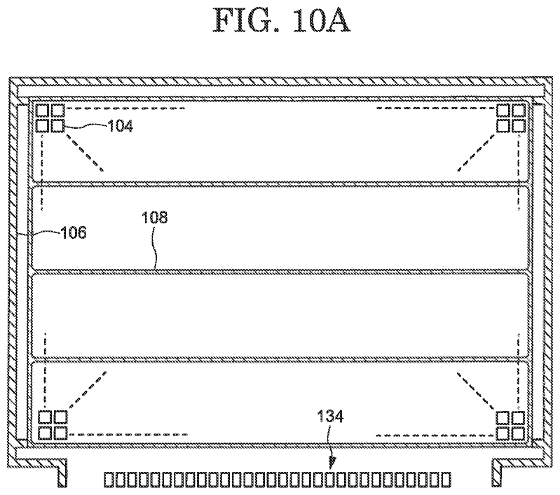

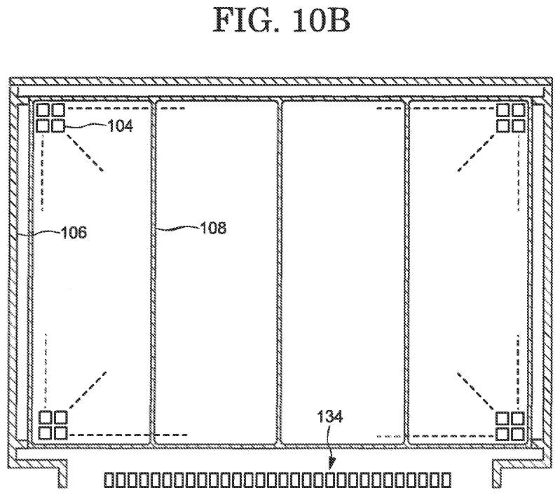

The third electrode 108 is not limited to a grid pattern, and may have a stripe (linear) pattern. For example, as shown in FIG. 10A, a vertical stripe pattern may be provided when the terminal part 134 is positioned at the lower end, or a horizontal stripe pattern may be provided as shown in FIG. 10B. The third electrode 108 may be disposed correspondingly, when the circuit configuration of the detection device 100 has anisotropy in resistance to electrostatic discharge. That is, the pattern extending in the longitudinal direction as shown in FIG. 10A may be applied to the third electrode 108 when the electrostatic discharge immunity in the longitudinal direction is low, and the pattern extending in the longitudinal direction as shown in FIG. 10B may be applied to the third electrode 108 when the electrostatic discharge immunity in the lateral direction is low. Further, as described above, the pattern density of the third electrode 108 may be appropriately adjusted.

Although not shown, the pattern density of the third electrode 108 in the vertical direction and the horizontal direction may be made different depending on the anisotropy of the electrostatic discharge resistance even when the third electrode 108 has the lattice pattern shown in FIG. 10A and FIG. 10B.

As described above, since the third electrode 108 is disposed on the detection part 102 provided in the shape of the substrate 200 having the insulating surface, electrostatic discharge immunity can be enhanced in the detection device 100 according to the present embodiment. As shown in this embodiment, since the third electrode 108 is directly connected to the second terminal 138 by the second wiring 112 and the first wiring 110 formed in the same layer, the third electrode 108 can be electrically separated from the detection part 102 formed on the lower layer side through the insulating layer, and can be prevented from being affected by electrostatic discharge. Further, the secondary discharge between the terminals can be prevented and the discharge current can be prevented from backflowing, by arranging the second terminal 138 connected to the third electrode 108 so as to be separated from the first terminal 136. Since the third electrode 108 and the first wiring 110 are covered with an insulating layer, damage due to friction can be prevented.

A structure which can be carried out by a person skilled in the art with appropriate design changes is also within the technical scope of the present invention as long as it includes the gist of the one embodiment of the present invention, based on the structure of the detection device described above as an embodiment of the present invention.

A person skilled in the art can come up with various modifications and modifications and these modifications and modifications also fall within the technical scope of the present invention within the scope of the concept of the present invention. For example, in one embodiment of the invention described above, additions, deletions, and changes made as appropriate by the operator, and additions, omissions, and changes in conditions are within the technical scope of the invention, unless they depart from the scope of the invention.

It is also to be understood that with respect to advantageous effects provided by the aspects described in one embodiment of the invention, those apparent from the description of the present invention, as well as those that may be reasonably anticipated by a person skilled in the art, are provided by one embodiment of the invention.

What is claimed is:

1. A detection device, comprising:
at least one first electrode disposed in a detection part;
a second electrode disposed outside the detection part and surrounding the detection part;
a third electrode overlapped with the detection part;
a first insulating layer between the at least one first electrode and the third electrode; and
a second insulating layer covering the third electrode.

2. The detection device according to claim 1, wherein a thickness of the first insulating layer is thinner than a thickness of the second insulating layer.

3. The detection device according to claim 1, wherein the at least one first electrode comprises a plurality of first electrodes,
the plurality of first electrodes is arranged in a matrix in a first direction and a second direction intersecting the first direction, and are spaced from each other, and
the third electrode is disposed to overlap a portion where the plurality of first electrodes are separated.

4. The detection device according to claim 3, wherein the third electrode is disposed parallel to the first direction or the second direction.

5. The detection device according to claim 3, wherein the third electrode has a grid pattern.

6. The detection device according to claim 5, wherein the third electrode has an intersecting portion, and the intersecting portion has a round shape.

7. The detection device according to claim 1, further comprising a first wiring connected to the third electrode that is provided outside the detection part.

8. The detection device according to claim 7, wherein the detection part has a rectangular-shaped region, and the first wiring is disposed along three sides of the rectangular-shaped region.

9. The detection device according to claim 7, further comprising a second wiring connecting the first wiring and the third electrode,
wherein the first wiring is arranged apart from the detection part.

10. The detection device according to claim 7, wherein an end of the second electrode overlaps with the first wiring.

11. The detection device according to claim 7, further comprising a terminal part including a plurality of first terminals electrically connected to the detection part and at least one second terminal electrically connected to the first wiring,
wherein the at least one second terminal is arranged on both sides of the terminal part.

12. The detection device according to claim 11, wherein each the plurality of first terminals is disposed at a first pitch, and
the at least one second terminal is spaced apart from the outermost first terminal of the plurality of first terminals by a length equal to or longer than the first pitch.

13. The detection device according to claim 12, further comprising a dummy terminal disposed between the outermost first terminal and the at least one second terminal.

14. The detection device according to claim 7, wherein another second terminal is arranged adjacent to the second terminal, and
both of the second terminals are connected to the first wiring.
